(19) United States
(12) Patent Application Publication
(10) Pub. No.: US 2013/0168968 A1
(43) Pub. Date: Jul. 4, 2013

(54) Wind Power to Electric Power Conversion System with Propeller at Top of Tower and Generators at Bottom of Tower

(71) Applicants: Dahai Dong, Princeton Jct, NJ (US); Xun Dong, Northcote (AU); Xiaowei Dong, Northcote (AU)

(72) Inventors: Dahai Dong, Princeton Jct, NJ (US); Xun Dong, Northcote (AU); Xiaowei Dong, Northcote (AU)

(21) Appl. No.: 13/727,544

(22) Filed: Dec. 26, 2012

(30) Foreign Application Priority Data
Dec. 29, 2011 (CH) 201110447757.1

(51) Int. Cl. F03D 1/00

(52) U.S. Cl. CPC F03D 1/00
USPC 290/55

(57) ABSTRACT

A wind power generator system installed on the ground or ocean floating surface includes wind propeller, tower, Z-shaped mechanical transmission module, multiple stage gear box, fixed ratio gear box, transmission device, and alternating current generators coupled by a clutch between any two generators. The wind propeller is installed on top of the tower and is connected to the top side of Z-shaped mechanical transmission module which transfers the revolution mechanical power from top of the tower to the bottom of the tower.

### PRIORITY

The present invention claims priority based on 35 USC section 119 and based on China Patent Application Number: 201110447757.1 Filed on Dec. 29, 2011

### FIELD OF THE INVENTION

The present invention relates to power generators and more particularly to power generators powered by the wind.

### BACKGROUND

The structure of traditional wind power generator is illustrated in FIG. 1. The wind propeller and the generator are installed at same level and at top of the tower. The tower must be strong enough to support the weight of generator. As the capacity of the generator increases, the tower building and turbine maintenance cost also increase. It is difficult and dangerous to perform maintenance to the generator at top of the tower, especially to those which suffer heavy shaking by wind and are installed on ocean floating surfaces.

FIG. 1 shows the structure of traditional wind power generator. Wind propeller 1, Transmission 2, and generator 3 are installed at same center horizontal level and at top of tower 5. Transmission 2 and generator 3 are the two major parts of wind turbine 4.

### SUMMARY

A wind power generator system may include a wind propeller being rotated by wind power, a tower to support the wind propeller, a Z-shaped mechanical transmission module including a central axis to be rotated by the wind propeller, a multiple stage gear box connected to the central axis, a fixed ratio gear box connected to the multiple stage gear box, a transmission device connected to the multiple stage gear box, an alternating current generator to generate electrical power from the power of the wind wherein the wind propeller is at substantially the top of the tower and the generator is at substantially the bottom of the tower, a top end of the Z-shaped mechanical transmission module and a bottom end of the Z-shaped mechanical transmission module positioned at top and bottom of the tower, respectively. The Z-shaped mechanical transmission module may include a central axel and a first bevel box at top of the central axel and a second bevel box at bottom of the axel. Each end of the central axel may include a universal joint to absorb vibration of the axel or tower.

The input of the multiple stage gear box may be connected to the bottom of the Z-shaped mechanical transmission module and wherein the output of the multiple stage gear box is connected to the fixed ratio gear box. The gear ratio of the multiple stage gear box may be from 1:1 to 1:50 which is adjusted manually or automatically. The input of the fixed ratio gear box may be connected to the multiple stage gear box and the output of the fixed ratio gear box may be connected to the transmission device. The input of the transmission device may be connected to the fixed ratio gear box and the output of the transmission device may be connected to multiple alternating current generators connected by a clutch between any two generators. The tower may be positioned on the surface of the ground. The tower may be positioned on the surface of the ocean or lake.

### BRIEF DESCRIPTION OF THE DRAWINGS

The invention may be understood by reference to the following description taken in conjunction with the accompanying drawings, in which, like reference numerals identify like elements, and in which:

FIG. 1 shows the structure of traditional wind power generator (Both propeller and generator are at top of tower);

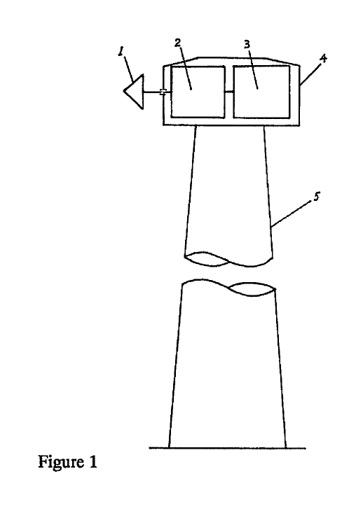

FIG. 2 shows the structure of the present invention “Wind Power to Electric Power Conversion System with Propeller at Top of Tower and Generators at Bottom of Tower”;

FIG. 3 shows the structure of Z-shaped mechanical transmission module of the present invention;

FIG. 4 shows another structure of Z-shaped mechanical transmission module of the present invention.

### DETAILED DESCRIPTION

This invention describes a design which installs generators connected by clutches on the ground. Since generators are at ground, it is feasible to install additional gear boxes. The gear boxes can raise the rotation speed to generate electricity at 60 Hz which can be directly connected to the power line system without using electricity conversion systems. The multiple AC generators with clutches make it feasible to adjust number of generators at working condition as speed of wind changes.

This invention describes a wind power generator system installed on the ground or water floating surface including wind propeller, tower, Z-shaped mechanical transmission module, multiple stage gear box, fixed ratio gear box, transmission device, and multiple alternating current generators. The wind propeller is installed on top of the tower and is connected to the top side of Z-shaped mechanical transmission module which transfers the revolution mechanical power from top of the tower to the bottom of the tower. This design makes all of other heavy systems can be installed on the ground or on a floating surface of water. The multiple stage gear box automatically adjust the output revolution speed into a certain designed range. The fixed ratio gear box may increase revolution speed at a fixed ratio to slight over 3600 revolution/min or 1800 revolution/min. The transmission device may adjust the speed to 3600 revolution/min or 1800 revolution/min. The alternating current generators generate electric current with 60 Hz which can be directly connected into power line system which has 60 Hz. If each generator has more than 2 pairs of magnetic poles, the speed of generator can be further reduced to generate electric current at 60 Hz. The number of generators at working condition is adjusted according to wind speed.

The present invention describes a wind power generator system which may be positioned on the ground or floating on the ocean or lake surface and which may include a wind propeller 1, a tower 5, a Z-shaped mechanical transmission module 21, a multiple stage gear box 22, a fixed ratio gear box 23, a transmission device 24, and alternating current generators 7 coupled by a clutch 8 between any two generators 7. The wind propeller 1 may be positioned on top of the tower 5. Z-shaped mechanical transmission module 21 may be positioned vertically along the tower and the Z-shaped mechanical transmission module 21 may include a pair of opposing gear boxes 25, one at the top end and the other one at the bottom end of the tower. The axel of the wind propeller may be connected to the top end gear box 25 of Z-shaped mechanical transmission module 21. The rotation of wind propeller 1 in response to wind energy may rotate the vertical axel 26 of the Z-shaped mechanical transmission module 21 through the bevel gears 27 in top gear box 25. The Z-shaped mechanical transmission module 21 may transfer the mechanical rotation power from top of the tower 5 to the bottom of the tower 5. The bottom bevel gears 27 in gear box 25 of the Z-shaped mechanical transmission module 21 may be connected to the multiple stage gear box 22. The output rotating speed of the multiple stage gear box 22 is manually or automatically adjusted to a certain range by a ratio of approximately 1:1 to 1:50 while the input rotating speed of the bottom gears 27 varies as wind force changes. The output axel of the multiple stage gear box 22 may be connected to the fixed ratio gear box 23. The fixed ratio gear box 23 may further raise the revolution speed of the output of the fixed ratio gear box 23 to approximately over 30 or 60 revolution/sec. The output axel of the fixed ratio gear box 23 may be further connected to the input of the transmission device 24. The transmission device 24 may adjust the output speed at constant speed of 30 or 60 revolution/sec. The output axel of transmission device 24 may be further connected to alternating current generators 7 which are connected by a clutch 8 between any two generators 7. The alternating current generators 7 may generate alternating electric current at approximately 60 Hz at speed of 60 or 30 revolution/sec or other frequencies and/or speed. Each generator 7 may include two magnetic poles or four magnetic poles, respectively or any other number of magnetic poles. Another embodiment of a wind power generator system may be similar to the system mentioned above, but multiple stage gear box 22, fixed ratio gear box 23, and transmission device 24 may have different series connection order with the similar function to keep generators 7 rotating at the designed speed. Another embodiment of a wind power generator system may be similar to the system mentioned above, but the generators 7 may be any kind of generator and can work at any rotating speed; the transmission device 24 may not be needed; the multiple stage gear box 22 and/or the fixed ratio gear box 23 may not needed. With this design, the electricity from the generator may require frequency and voltage conversion before sending the current/power to the power line system.

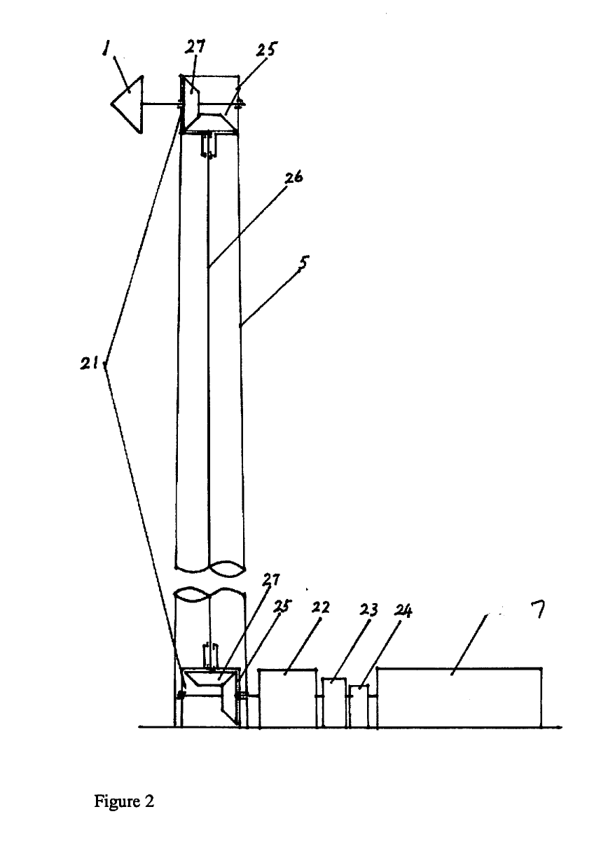

FIG. 2 illustrates the structure of the present invention. FIG. 2 illustrates the wind propeller 1, the tower 5, the generators 7, the clutches 8, the Z-shaped mechanical transmission module 21, the multiple stage gear box 22, the fixed ratio gear box 23, the transmission device 24, the bevel gear boxes 25, the central axel 26, and the bevel gears 27.

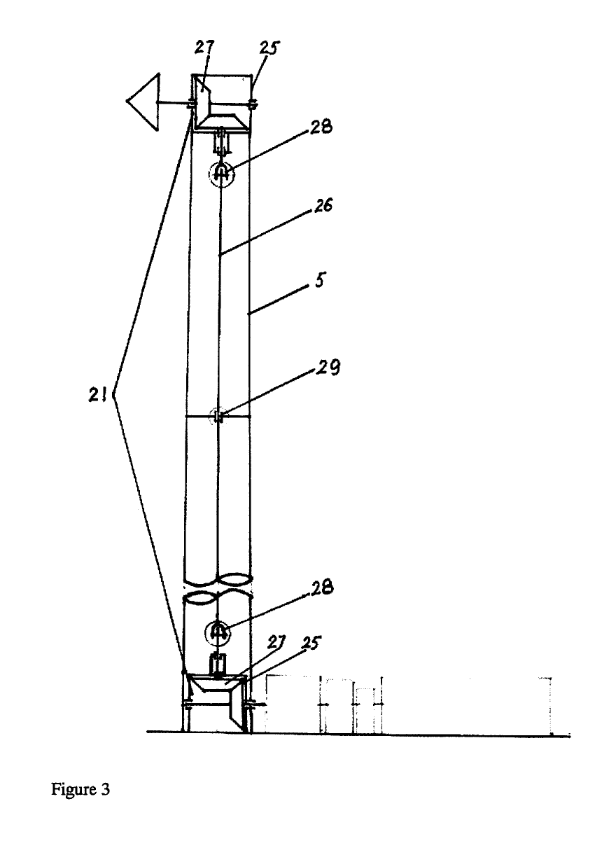

FIG. 3 illustrates the structure of Z-shaped mechanical transmission module 21. FIG. 3 shows some aspects not illustrated in FIG. 2. FIG. 3 illustrates a pair of opposing universal joints 28 which may be located at top and bottom ends of central axel 26. The universal joints 28 may adjust and reduce energy loss when the tower 5 and central axel 26 are bent by wind. One or multiple axle bearing(s) 29 may be installed along central axel 29. The axle bearings 29 may reduce axle vibration and support and retain the central axel 26 at the center of tower 5.

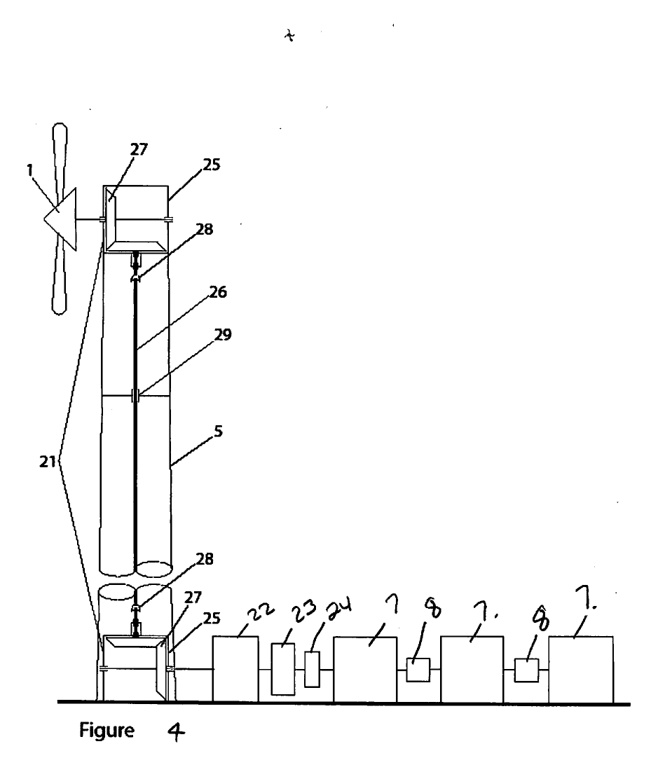

FIG. 4 illustrates the structure of Z-shaped mechanical transmission module 21. FIG. 4 shows some aspects not illustrated in FIG. 2 and FIG. 3. FIG. 4 illustrates a pair of opposing universal joints 28 which may be located at top and bottom ends of central axel 26. The universal joints 28 may adjust and reduce energy loss when the tower 5 and central axel 26 are bent by wind. One or multiple axle bearing(s) 29 may be installed along central axel 29. The axle bearings 29 may reduce axle vibration and support and retain the central axel 26 at the center of tower 5.

FIG. 4 additionally illustrates multiple AC generators 7 which may be coupled by a clutch 8 between any 2 AC generators 7 may replace the single generator 7. The advantage may be that the electric output from the multiple generators 7 increases as wind speed increases, and the arrangement with low speed wind can still generate electric power while only one generator 7 is operating with the remaining generators being decoupled by the clutch 8.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A wind power generator system, comprising a wind propeller being rotated by wind power, a tower to support the wind propeller, a Z-shaped mechanical transmission module including a central axis to be rotated by the wind propeller, a multiple stage gear box connected to the central axis, a fixed ratio gear box connected to the multiple stage gear box, a transmission device connected to the multiple stage gear box, and alternating current generators coupled by a clutch between any two generators to generate electrical power from the power of wind wherein the wind propeller is at substantially the top of the tower and the generators are at substantially the bottom of the tower, a top end of the Z-shaped mechanical transmission module and a bottom end of the Z-shaped mechanical transmission module are positioned at top and bottom of the tower, respectively

2. A wind power generator system as in claim 1, wherein the Z-shaped mechanical transmission module includes a central axel and a first bevel box at top of the central axel and a second bevel box at bottom of the axel.

3. A wind power generator system as in claim 2 wherein each end of the central axel includes a universal joint to absorb vibration of the axel or tower.

4. A wind power generator system as claim 1, wherein the input of the multiple stage gear box is connected to the bottom of the Z-shaped mechanical transmission module and wherein the output of the multiple stage gear box is connected to the fixed ratio gear box.

5. A wind power generator system as in claim 4, wherein the gear ratio of the multiple stage gear box is from 1:1 to 1:50 which is adjusted manually or automatically.

6. A wind power generator system as described in claim 1, wherein the input of the fixed ratio gear box is connected to the multiple stage gear box and wherein the output of the fixed ratio gear box is connected to the transmission device.

7. A wind power generator system as in claim 1, wherein the input of the transmission device is connected to the fixed ratio gear box and the output of the transmission device is connected to the alternating current generator.

8. A wind power generator system as in claim 1, wherein the tower is positioned on the surface of the ground.

9. A wind power generator system as in claim 1, wherein the tower is positioned on the surface of the ocean or lake.

10. A wind power generator system as in claim 4, wherein the gear boxes and transmission device are connected in different series orders.

11. A wind power generator system as described in claim 1, wherein the generators can work at a broad range of rotating speed; the multiple stage gear box, the fixed ratio gear box, and/or the transmission device may not needed to make the system generate electricity at various rotating speeds.

12. A wind power generator system as described in claim 1, wherein a clutch adjusts the number of generators operating according to speed of wind.
